(19) United States
(12) Patent Application Publication
(10) Pub. No.: US 2026/0081412 A1
(43) Pub. Date: Mar. 19, 2026

(54) HOT-STICKABLE DISK

(71) Applicant: Hubbell Incorporated, Shelton, CT (US)

(72) Inventors: Joseph Paul Alfaro, Artesia, CA (US); Paul Alfaro, JR., Orange, CA (US); Kyle Randy Herman, Foothill Ranch, CA (US)

(21) Appl. No.: 19/329,724

(22) Filed: Sep. 16, 2025

Related U.S. Application Data
(60) Provisional application No. 63/695,409, filed on Sep. 17, 2024.

(51) Int. Cl. H02G 15/00

(52) U.S. Cl. CPC H02G 15/00

(57) ABSTRACT

The barrier system includes a barrier and a retainer. The barrier includes a body with an outer perimeter and an inner perimeter forming an aperture configured to receive a support. A first groove extends at least partially between the outer perimeter and the inner perimeter. A second groove extends at least partially between the outer perimeter and the inner perimeter. The second groove is spaced apart from the first groove. A channel extends through the body between the outer perimeter and the inner perimeter. The channel is disposed between the first groove and the second groove. The retainer includes a retainer body having a first projection and a second projection. The first projection can be received in the first groove and the second projection can be received in the second groove. The retainer body can extend across the channel and limit movement of the support through the channel

### CROSS-REFERENCE TO RELATED APPLICATION

This application claims the benefit of U.S. Provisional Application No. 63/695,409, filed Sep. 17, 2025, the entire contents of which is incorporated herein by reference in its entirety.

### FIELD

The present disclosure relates to a barrier for limiting access to energized elements. More particularly, the present disclosure relates to eccentric barrier that resists decoupling in extreme environmental conditions.

### BACKGROUND

Electrical components (e.g., power lines and other energized elements) are built across different environments to bring power to consumers and businesses. To convey electrical energy to consumers across wide and diverse areas, energized components need to be built within many environments, some of may be undeveloped or otherwise include an abundance of wildlife. Wildlife may be interested in these structures and not realize the dangers posed by the energized elements.

To keep the wildlife safe, linesman or other technicians may install guards at or near the energized elements. These guards may assist in providing a barrier between the animals'habitat and the energized elements, thereby reducing the animals that are inadvertently harmed. The guards also help to maintain the integrity of the system by limiting shorts or other electrical failures caused when animals interact with the energized elements.

The guard (e.g., a barrier disc) can be a simple (1 step installation) hot stick application. Installation may also occur with a tool (e.g., a shotgun tool) by pushing or pulling the component on the equipment. The guard can also be installed via rubber glove work method (e.g., manually).

Some environments where guards are installed may produce high winds, which can cause the guard to rotate. Rotating bodies experience a centrifugal force, which is a force directed radially outwardly from a body's center of mass.

The guards typically include a pathway to insert the guard around its supporting element. As the guard rotates, the centrifugal force may at times be directed in an opposite direction from the pathway. In mild conditions, the guard may be capable of resisting the centrifugal force (e.g., via a frictional force). However, in high winds, the centrifugal force may exceed any other forces and may cause the guard to decouple from its support, which enables wildlife to access potentially dangerous areas.

Additional components to secure the pathway could be hot stick or shotgun installed. Although technicians can attempt to secure the pathway closed (e.g., with a zip tie or other common fastener) this may be an imperfect and impractical method to keep the guard secured. The body of the guard may be flexed to fit around a support and overtightening the guard with a common fastener after it is received around the support may cause it to fracture. Alternatively, while simply closing an opening to the pathway may initially limit the guard from becoming disconnected, the guard may still decouple because of the centrifugal force and ride along the technician's fastener, which can also fail.

A need for a way to ensure that a guard will remain coupled to its support during various environmental conditions is needed to limit failure of the guards and ensure that wildlife remains protected.

### SUMMARY

Various embodiments of the present disclosure can overcome various of the aforementioned and other disadvantages associated with known guards and offer new advantages as well.

According to one aspect of the present disclosure there is provided a barrier system for use in an electrical system. A retainer can be connected to a barrier to secure the barrier to a support.

According to one aspect of the present disclosure there is provided a barrier system for use in an electrical system. The barrier system includes a barrier and a retainer. The barrier includes a body with an outer perimeter and an inner perimeter forming an aperture configured to receive a support. A first groove extends at least partially between the outer perimeter and the inner perimeter. A second groove extends at least partially between the outer perimeter and the inner perimeter. The second groove is spaced apart from the first groove. A channel extends through the body between the outer perimeter and the inner perimeter. The channel is disposed between the first groove and the second groove. The retainer includes a retainer body having a first projection and a second projection. The first projection can be received in the first groove and the second projection can be received in the second groove. The retainer body can extend across the channel and limit movement of the support through the channel.

According to one aspect of the present disclosure there is provided a barrier system for use in an electrical system. The barrier system includes a barrier and a retainer. The barrier includes a body with an outer perimeter and an inner perimeter forming an aperture configured to receive a support. The body further includes a first groove and a channel. The first groove extends at least partially between the outer perimeter and the inner perimeter. The first groove includes a plurality of slots. Each slot is oriented along a circumferential direction of the body. The channel extends through the body between the outer perimeter and the inner perimeter. The channel is spaced apart from the first groove. The retainer can be removably coupled to the barrier and includes a retainer body and a first projection that extends from the retainer body. The first projection can be selectively received within one slot of the plurality of slots. The retainer body can extend across the channel and limit movement of the support through the channel.

According to one aspect of the present disclosure there is provided barrier for use in an electrical system. The barrier includes a body, an aperture, a channel, a first groove, and a second groove. The body is formed from a plurality of spaced apart first ribs. The aperture is formed at a geometric center of the body. The channel extends from the aperture to an outer perimeter of the body. The first groove is disposed on a first side of the channel and extends at least partially between the aperture and the outer perimeter. The first groove includes a first plurality of elongated slots arranged in a circumferential direction of the body. The second groove is disposed on a second side of the channel and extends at least partially between the aperture and the outer perimeter. The second groove includes a second plurality of elongated slots arranged in the circumferential direction of the body.

According to one aspect of the present disclosure there is provided retainer configured to secure a barrier to a support. The retainer includes an elongated body, a first projection, and a second projection. The first projection extends from a lower surface of the body. The first projection includes a first end and a first shaft extending between the first end and the body. The second projection extends from the lower surface of the body. The second projection includes a second end and a second shaft extending between the second end and the body. The first projection and the second projection can connect to the support in a ratcheting manner.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a perspective view of a disk guard according to another example.

FIG. 2 is a perspective view of a retention member for use with the disk guard of FIG. 2.

FIG. 3 is a front view of the retention member of FIG. 2.

FIG. 4 is a side view of the retention member of FIG. 2.

FIG. 5 is a perspective view of the retention member of FIG. 2 connected to the disk guard of FIG. 1.

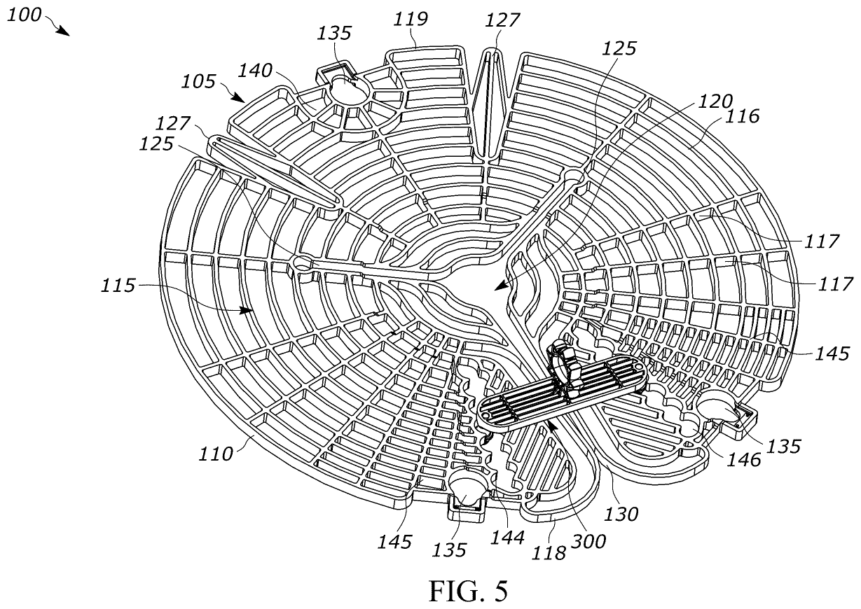

FIG. 6 is a bottom view of the connected retention member and disk guard of FIG. 5.

FIG. 7 is a perspective view of a hot stick positioning the disk guard of FIG. 1 on an electrical device.

FIG. 8 is a top view of the hot stick positioning the retention member of FIG. 2 onto the disk guard of FIG. 1.

### DETAILED DESCRIPTION

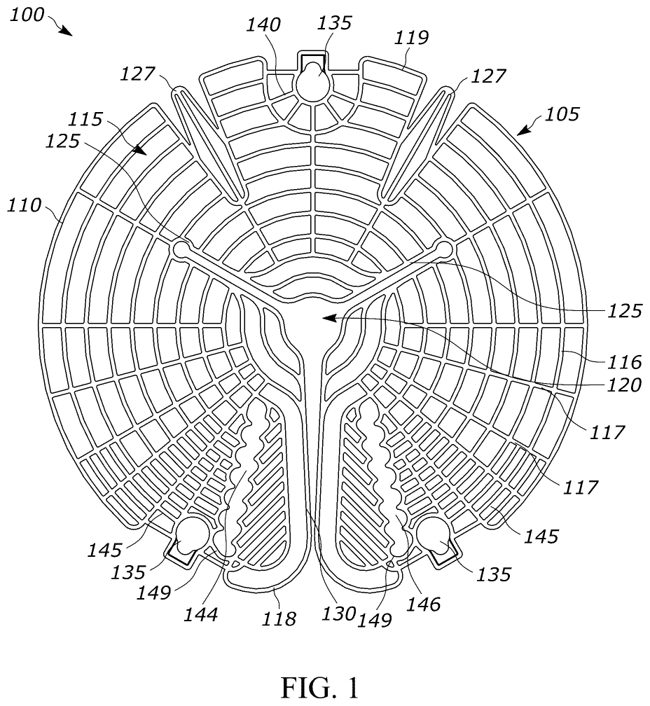

FIG. 1 illustrates one example of a guard or barrier 100 according to the present disclosure. The guard 100 includes a body 105 that is illustrated as having a substantially circular shape (e.g., a substantially circular outer perimeter 110). However, other examples of the guard 100 may include a body with a different shape (e.g., elliptical, triangular, rectangular, etc.).

In some forms, the body 105 may not be fully solid and may include a webbed region 115, which may be made up of circumferentially extending webs or ribs 116. For example, the webs 116 in the webbed region 115 may be disposed radially inside of the outer perimeter 110 and may include a similar shape (e.g., circular) as the outer perimeter 110.

In certain forms, the circumferential webs 116 may be substantially equally spaced from one another in the radial direction, although in other examples the webs 116 may have unequal spacing. A void may exist between adjacent webs 116 in the radial direction, which may permit airflow to pass through the body 105.

In some forms, the webbed region 115 may further include radial webs or ribs 117 that extend along a radial direction of the body 105. For example, the radial webs 117 may extend from the outer perimeter 110 toward the center, although the radial webs 117 may extend along any length of the circumferential direction.

In certain forms, at least some of the radial webs 117 may be unequally spaced around the circumference of the body 105. For example, the spacing of the radial webs 117 on the first half 118 of the body 105 may have a different spacing than the radial webs 117 on a second half 119 of the body 105. The illustrated example includes radial webs 117 that are equally spaced relative to the other radial webs 117 on the same half 118, 119 of the body 105, although other examples may include unequal spacing throughout the entire body 105.

With continued reference to FIG. 1, the webbed region 115 may radiate outwardly from a center of the body 105. The center may include an aperture 120, which as described in more detail below, may receive an electrical component or support. These terms may be used throughout to designate any element that the guard is coupled to (e.g., a bushing, a conductor, an insulator, a non-energized structure supporting energized components, etc.). A center point of the aperture 120 may represent a geometric center or centroid of the body 105.

In some forms, one or more channels 125 (e.g., two shown) may extend outwardly in the radial direction from the aperture 120. The illustrated channels 125 are each formed on the second half 119 of the body 105, although any configuration (e.g., one or more on the first half 118) may be constructed.

In certain forms, each channel 125 may be formed as an elongated section that extends in the radial direction outwardly from the aperture 120. The end of each channel 125 may include a rounded region (e.g., substantially circular in shape) that may be wider than the remainder of the respective channel 125.

In one form, a radial web 117 may extend between a channel 125 and the outer perimeter 110. Although in other examples, the radial web 117 and the channel 125 may be spaced apart from one another in the circumferential direction.

The body 105 may also include an insertion pathway 130. Like the channels 125, the insertion pathway 130 may extend outwardly in the radial direction from the aperture 120. The illustrated insertion pathway 130 may be formed on the first half 118 of the body 105.

In some forms, the channels 125 and the insertion pathway 130 may be similar. For example, they may each provide an opening within the body 105 (e.g., through which air or objects may pass) that extends in the radial direction from the aperture 120. In some forms, the channels 125 and the insertion pathway 130 may be equally spaced (e.g., about 120°apart), although in other example, there may be different (e.g., unequal spacing).

In certain forms, the insertion pathway 130 may differ from the channels 125 because the insertion pathway 130 may extend to the outer perimeter 110 and provide a pathway to reach the aperture in the radial direction of the body 105. The other perimeter 110 may therefore not form a closed perimeter.

The body 105 may be constructed from an at least partially flexible material. The guard 100 illustrated in FIG. 1 may show the body 105 in a neutral position. For example, walls forming the insertion pathway 130 may extend toward one another and eventually contact one another proximate to the outer perimeter 110. However, as described in more detail later, the body 105 may flex so that the distance between the walls increases and the insertion pathway 130 widens.

The body 105 may include one or more holes 135 (e.g., three shown) proximate to the outer perimeter 110. As described in more detail below, a tool (e.g., a hot-stick - not shown) may be inserted into one of the holes 135 to manually position the guard 100 around a support.

As described above, the first half 118 may differ from the second half 119 of the body 105 because there is a greater concentration of webs 116, 117 in the first half 118 than in the second half 119. Similarly, the holes 135 may differ based on their positioning on the body 105.

For example, the illustrated body 105 includes two holes 135 on the first half 118 and one hole 135 on the second half 119, although any number or configuration may be used.

In some forms, the body 105 may include at least one compressive region 127 (e.g., two shown in FIG. 1). The compressive regions 127 may be disposed substantially opposite of the insertion pathway 130. The compressive regions 127 may permit the body 105 to compress around that location to permit the insertion pathway 130 to widen.

As shown in FIG. 1, the support section 140 may be disposed between the compressive regions 127. Each compressive region 127 may include a wider middle section and a narrower outer section (e.g., proximate to the other perimeter 110). The outer perimeter 110 of the body 105 may also be discontinuous on either side of each compressive region 127. When a force is applied to the body 105 to expand the width of the insertion pathway 130 (e.g., expand from a neutral position), the discontinuous sections of the outer perimeter 110 on either side of a respective compressive region 127 may move proximate to one another is the middle section of the compressive region 127 flattens out and decreases in width.

In some forms, the body 105 may include a first groove 144 and a second groove 146, which may be spaced apart from the first groove across the insertion pathway 130. The illustrated first and second grooves 144, 146 may be substantially symmetrical to one another and may extend in a substantially radial direction.

In certain forms, the first groove 144 and the second groove 146 may each be formed by a series of adjacent elongated slots 149. Each slot 149 be oriented at least partially in the circumferential direction and may be slightly offset from the adjacent slots.

In certain forms, the webs 117 of the webbed region 115 on the first half 118 may be denser in an area surrounding the first and second grooves 144, 146. In other examples, the webs 116 may be denser proximate to the first and second grooves 144, 146, or the first half 118 could have substantially the same density of webs.

In some examples, the first half 118 may be constructed from a first material and the second half 119 may be constructed from a second material (e.g., two materials are introduced into a mold). The first material may be denser than the second material, which may make the first half 118 more massive than the second half 119.

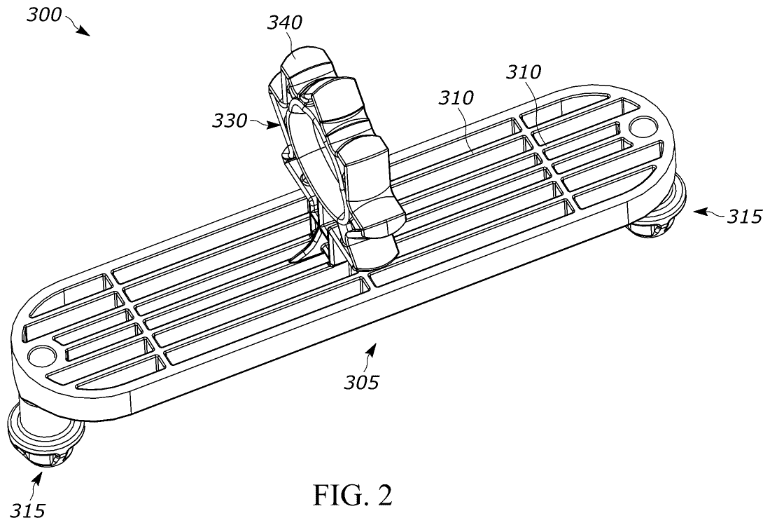

As shown in FIGS. 2 to 4, a retainer 300 is shown. As described in more detail below, the retainer 300 may be used to assist in securing the guard 100 to a support 50.

In some forms, the retainer 300 includes a body 305. The illustrated body 305 is an elongated body, although the body 305 may have any shape. The illustrated body 305 may not be solid and may include a plurality of ribs 310. Spacing between the ribs 310 may permit airflow through the body 305.

In some forms, an extension 315 may extend from either end of the body 305. In the illustrated example, both extensions 315 may extend in the same direction from the body 305. However, extensions 315 in other examples may extend in other direction, and/or a different number (e.g., one, three, four, etc.) of extensions 315 may extend from the body 305.

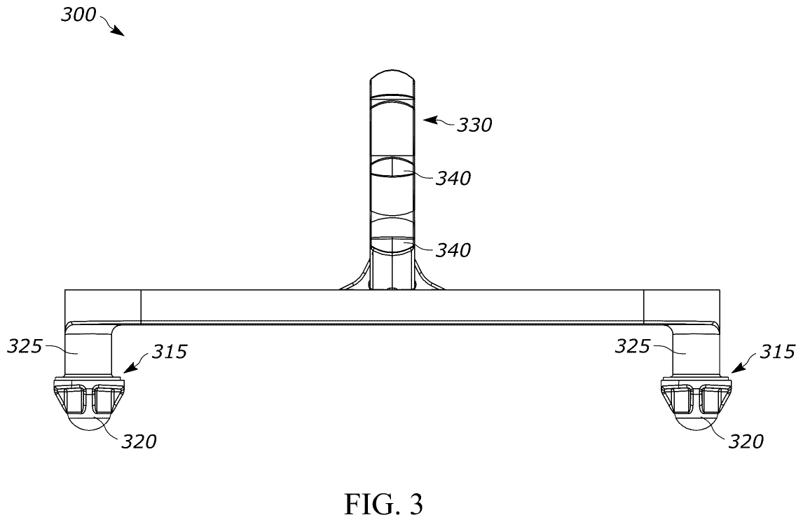

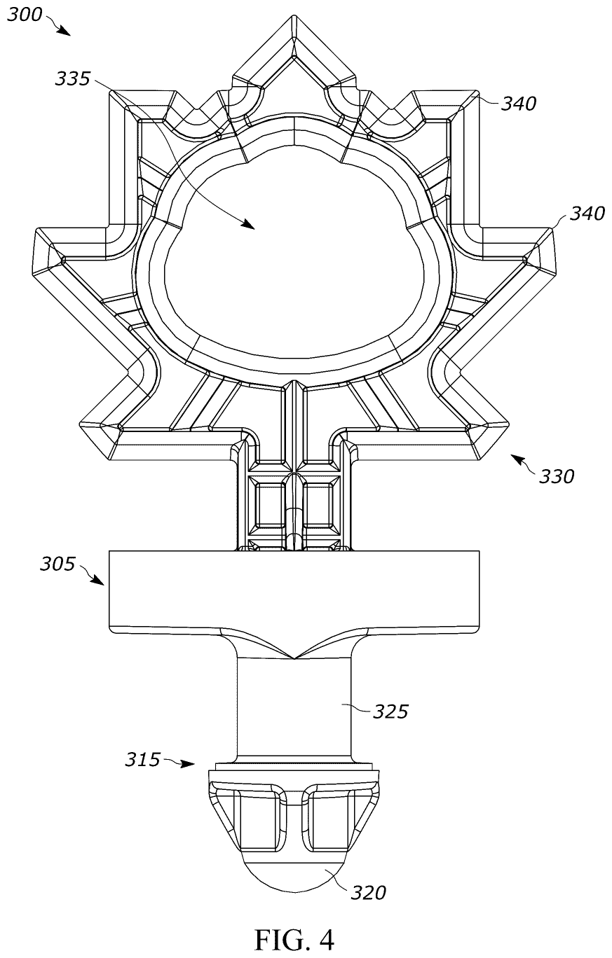

As shown in FIGS. 3 and 4, some forms of the extensions 315 may include an end 320 with a conical or frustoconical shaped section. For example, each end 320 may be narrower in a direction distal to the body 305. However, other examples may include one or more ends 320 with a different shape.

In some forms, each extension 315 also includes a shaft 325 disposed between the body 305 and the end 320. Each illustrated shaft 325 may be substantially cylindrical in shape and may have a width that is less than the maximum width of the end. In other examples, one or more of the shafts 325 may have a different shape.

In some forms, a projection 330 may extend from the surface of the body 305. In the illustrated example, the projection 330 may be disposed proximate to a center of the body 305. Additionally, the projection 330 may extend in the opposite direction than the extensions 315.

As shown in FIG. 4, the projection 330 may include an inner width and an outer width so that the projection includes a central opening 335. In the illustrated example, the central opening 335 may have a rounded shape (e.g., substantially circular, substantially elliptical, etc.), although in other examples the central opening 335 could have another shape.

With continued reference to FIG. 4, the outer width of the projection 330 may be at least partially formed from a series of protrusions 340. The illustrated protrusions 340 may each extend to a point, although other examples may include one or more protrusions with a different shape.

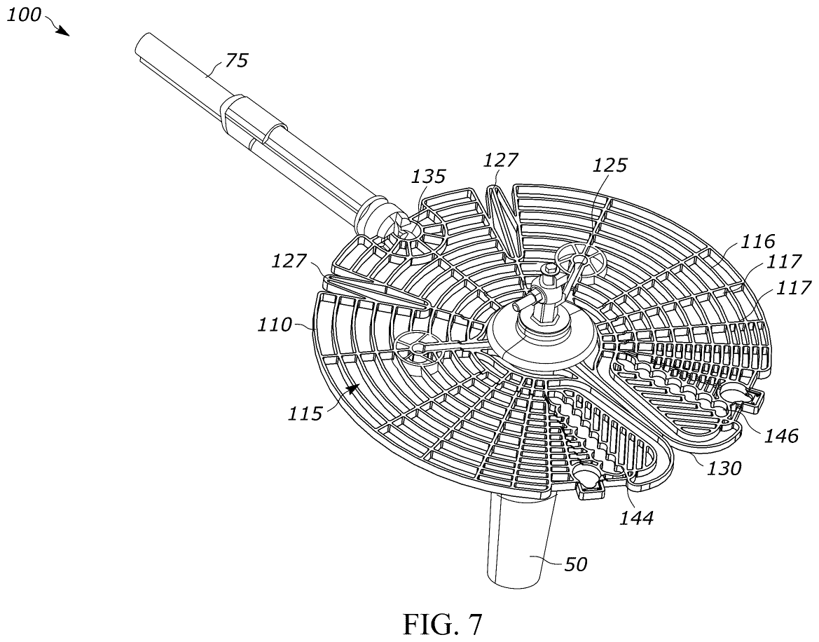

In use, the guard 100 may be positioned so that a support 50 is received within the aperture 120. As shown in FIG. 7, coupling the guard 100 to the support 50 may involve using a tool 75 (e.g., a hot-stick) to position the guard 100 without touching the support 50. The tool 75 may be removable coupled to the guard 100 via at least one of the holes 135. The tool 75 can move (e.g., push or pull) the guard to the support 50 and adjust the insertion pathway 130 (e.g., move the body 105 from a neutral position to a second position) to accommodate the support 50. In the second position, the walls of the insertion pathway 130 may be moved against a bias toward the neutral position to form a wider area. In some forms, the walls of the aperture 120 may provide a clamping force against the support as the insertion pathway 130 attempts to return to the neutral position. Although not shown, the channels 125 may also widen as the insertion pathway moves away from the neutral position to accommodate the support.

Depending on the size of the support 50, the width of the insertion pathway 130 and the compression in the compressive regions 127 may change. In other words, a single size of a guard 100 may be used with a variety of sized supports, which may assist in limiting overall manufacturing costs.

In use, an external force (e.g., a wind force) may act on the guard 100. For example, the guard 100 may be installed in places that experience high winds (e.g., up to and/or exceeding about 80-90 mph) that exert a force on the guard 100. The external force (e.g., wind force) may act proximate to the outer perimeter 110, which creates a torque sufficient to cause rotation of the guard 100 about the support. In windy environments, the guard 100 may rotate about the support.

When an object moves in a circular path, a centrifugal force acts on the body from the center of mass in a direction away from the center of rotation. In the illustrated example, the center of mass may be proximate to the center of rotation, which may be proximate to the center of the aperture 120. During the course of rotation, the centrifugal force may be directed in a direction away from the insertion pathway 130.

To prevent the guard 100 from inadvertently disconnecting from the support, the retainer 300 may be used to secure the guard 100 to the support. As described in more detail below, the retainer 300 may block the guard 100 from disconnecting from the support when the centrifugal force is directed in the direction opposite from the insertion pathway 130.

The retainer 300 may begin disconnected from the guard 100 to permit the guard to be connected to the support (e.g., as described above). Once the guard is connected to the support, the retainer 300 may be connected to the guard 100.

In some forms, the retainer 300 may be positioned proximate to the first half 118 of the guard 100. More specifically, the retainer 300 may be positioned so that it extends across the insertion pathway 130. The retainer 300 may also be oriented so that the extensions 315 face the webbed region 115.

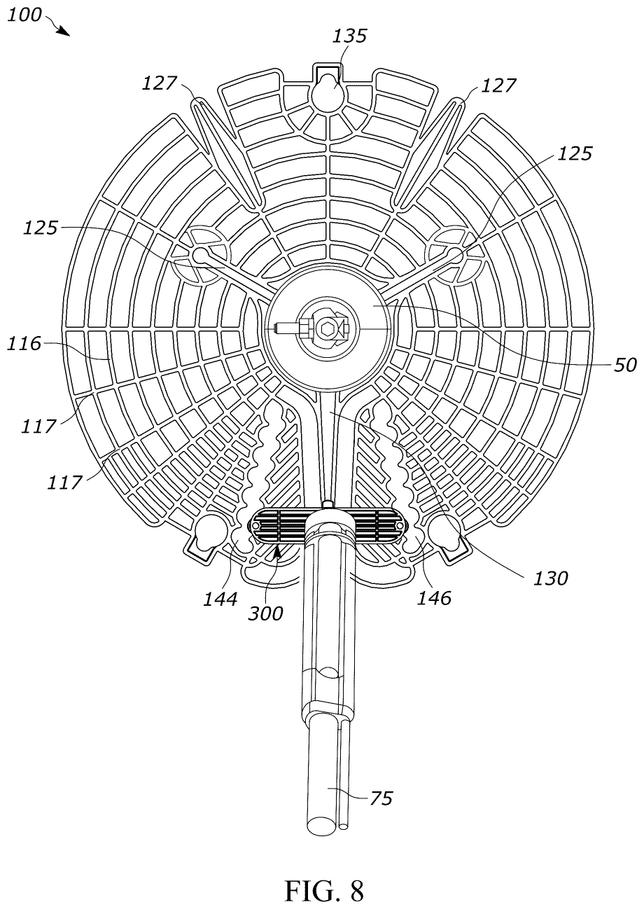

In this position, the extensions 315 may be generally aligned with the first and second grooves 144, 146 of the body 105. Once properly aligned, an external force (e.g., being pushed/pulled by a technician, via a technician operated tool, etc.) may be applied to the retainer 300 to move the extensions 315 at least partially through the respective grooves 144, 146. As shown in FIG. 8, the tool 75 may be used to position the retainer 300 in the selected position.

In some forms, the retainer 300 may be oriented so that it is substantially perpendicular with respect to the insertion pathway 130. The extensions 315 may therefore be positioned proximate elongated slots 149 that are directly across from one another. As described in more detail below, the pair of elongated slots 149 selected may be at least partially determined by the size of the support.

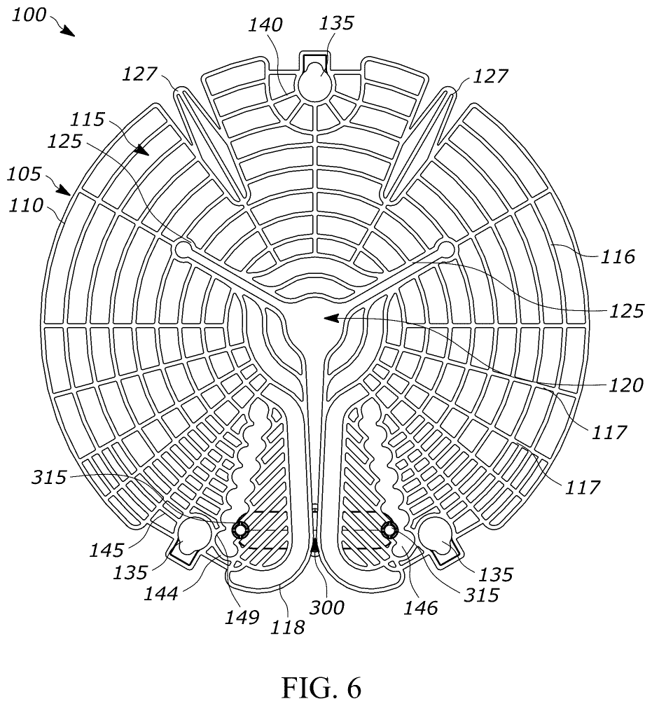

As the force is applied, the end 320 of each extension 315 may pass through a respective elongated slot 149. As shown in FIG. 6, the width of the body 305 (and more particularly the distance between the extensions 315) may be approximately a distance between the outer ends of grooves 144, 146 (e.g., as measured along adjacent elongated slots 149). When inserted through the grooves 144, 146, the ends 320 may sit proximate to the inner edge (e.g., proximate to the insertion pathway 130) of each elongated slot 149.

In some forms, the end 320 of each extension 315 may have a conical or frustoconical shape, where a portion proximate to the shaft 325 is wider than the free end. When inserted through the respective elongated slot 149, the shaft 325 may pass at least partially through the respective elongated slot 149 to permit the ends 320 to also pass through. Once each end 320 is through the respective slot 149, the upper portion of the end 320 may rest against a lower surface of the webbed region 115 to at least partially retain the retainer 300 in place.

In certain forms, the body 305 is a fixed length (although other examples may include a telescoping body). Because the body 305 has a fixed length, it may fit only into specific elongated slots 149. The slots 149 that can receive the extensions 315 may vary based on the size of the support 50. For example, the insertion pathway 130 may become wider to accommodate a larger support. As the insertion pathway 130 gets wider, the distance between the grooves 144, 146 also gets wider, thus changing which slots 149 can accommodate the extensions 315.

The retainer 300 may be used to tighten and contract the guard 100 around the support 50. For example, the retainer 300 may be inserted into an inner pair of elongated slots 149 and moved away from the aperture 120. As this movement occurs, the retainer 300 could assist in pulling the grooves 144, 146 together, thereby compressing the insertion pathway 130 around the support 50.

In some forms, the extensions 315 of the retainer 300 may be initially inserted in slots 149 proximate to the inner perimeter (e.g., proximate to the aperture 120). The distance between these slots 149 may permit entry to the extensions 315, but the retainer 300 may not be secured within the slots 149. For example, both ends 320 may not sit against the inner edge of the respective slot 149.

A technician may then move the retainer 300 away from the center aperture 120 to secure it in place (e.g., using the tool 75 as shown in FIG. 8). In some forms, the retainer 300 may rachet as it moves away from the aperture 120. As the retainer 300 moves, the extensions 315 may be in increased contact with the inner edges of the slots 149. The retainer 300 may continue to move away from the aperture 120 until both extensions 315 are disposed against the inner edge of the respective slots 149. In this position, the retainer 300 may be tight within the grooves 144, 146 so that it is secured against movement away from the aperture 120. For example, the ratcheting may provide one way movement away from the aperture 120 but may limit movement toward the aperture 120 without additional technician intervention. This may limit the loosening of the guard 100 from a support during use.

In other examples, the method to connect the retainer 300 to the slots 149 may be reversed. For example, the retainer 300 may be initially positioned proximate to an outer perimeter and positioned into an outer end of the slots 149 distal to the aperture 120. The retainer 300 can then move toward the aperture 120 in a ratcheting manner until the retainer 300 is tight against the inner surface of the grooves 144, 146.

In alternate examples, the grooves 144, 146 and the extensions 315 may be reversed. In other words, the retainer 300 may include one or more slots 149, which may receive extensions 315 that extend from a surface of the guard 100. The connection between the extensions 315 and slots 149 may be similar regardless of their orientation.

In certain forms, the guard 100 may have a geometric center or centroid in a center of the body 105 (e.g., in a center of the aperture 120). A center of mass of the guard 100 may be spaced apart from the geometric center. For example, the center of mass may be located in the first half 118 of the body 105. Specifically, the center of mass may be located along the insertion pathway 130 (e.g., along the center of the insertion pathway 130, although other locations of the center of mass may be used). Although the center of mass could be located at any location on the first half 118.

The center of mass located on the first half 118 away from the centroid may be achieved through a greater density of webs 116, 117, by more massive support sections 145, and/or by a greater number of support sections 145 in the first half 118 as compared to the second half 119. More specifically, the section of the body 105 proximate to the insertion pathway 130 is more massive than the opposite section.

When connected to a support, the centrifugal force from the wind acts outwardly from the center of mass along the insertion pathway 130. For example, the first half 118 of the body 105 may be substantially symmetrical about the insertion pathway 130 so that the center of mass is oriented substantially in the center of the insertion pathway 130.

Positioning the center of mass away from the centroid and within the insertion pathway 130 always orients the centrifugal force in a radial direction along the insertion pathway 130 toward the outer perimeter 110.

This force draws the wall of the aperture 120 into the support 50. In other words, the centrifugal force forces the body 105 into contact with the support 50 and prevents the support 50 from traveling down the insertion pathway 130. Because the centrifugal force is always directed outwardly, the body 105 will remain in this position as it continues to rotate about the support 50.

Orienting the center of mass along the insertion pathway 130 also helps to ensure that the centrifugal force is not directed into a wall, which could create frictional forces and limit the ability of the guard 100 to rotate.

As shown in FIG. 1, some examples of the guard 100 may have a denser pattern of webs proximate to the grooves 144, 146 so that the center of mass is spaced apart from the centroid. Although the retainer 300 may be a primary mechanism for retaining the guard 100 to the support 50, the geometry of the guard 100 may provide secondary assistance in retaining the guard 100. However, the retainer 300 may be sufficient to secure a guard with a centroid and center of mass at the same location.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A barrier system for use in an electrical system, the barrier system comprising:
a barrier including,
a body having an outer perimeter and an inner perimeter forming an aperture configured to receive a support,
a first groove extending at least partially between the outer perimeter and the inner perimeter,
a second groove extending at least partially between the outer perimeter and the inner perimeter, wherein the second groove is spaced apart from the first groove, and
a channel extending through the body between the outer perimeter and the inner perimeter, the channel being disposed between the first groove and the second groove, and
a retainer including a retainer body having a first projection and a second projection;
wherein the first projection is configured to be received in the first groove and the second projection is configured to be received in the second groove; and
wherein the retainer body is configured to extend across the channel and limit movement of the support through the channel.

2. The barrier system of claim 1, wherein the body includes radial ribs that extend at least partially between the outer perimeter and the inner perimeter, wherein the body includes a greater density of radial ribs proximate to the channel.

3. The barrier system of claim 2, wherein the body further includes circumferential ribs spaced around the body, and wherein the circumferential ribs are equally spaced from one another in a radial direction.

4. The barrier system of claim 1, wherein the body includes an opening spaced apart from the aperture and proximate to the outer perimeter, the opening configured to receive a tool for maneuvering the body onto the support.

5. The barrier system of claim 1, wherein the first projection of the retainer includes a first end with a frustoconical shape and the second projection of the retainer includes a second end with a frustoconical shape, and wherein the first end is configured to contact a perimeter of the first groove and the second end is configured to contact a perimeter of the second groove.

6. The barrier system of claim 1, wherein the first groove includes a series of discrete slots, each slot being oriented along a circumferential direction, and wherein the first projection is configured to extend at least partially through one of the slots.

7. A barrier system for use in an electrical system, the barrier system comprising:
a barrier including,
a body including,
an outer perimeter,
an inner perimeter forming an aperture configured to receive a support,
a first groove extending at least partially between the outer perimeter and the inner perimeter, the first groove including a plurality of slots, wherein each slot oriented along a circumferential direction of the body,
a channel extending through the body between the outer perimeter and the inner perimeter, wherein the channel is spaced apart from the first groove; and
a retainer configured to removably couple to the barrier, the retainer including,
a retainer body, and
a first projection extending from the retainer body;
wherein the first projection is configured to be selectively received within one slot of the plurality of slots; and
wherein the retainer body is configured to extend across the channel and limit movement of the support through the channel.

8. The barrier system of claim 7, wherein the body includes a plurality of spaced apart radial ribs that each extend at least partially between the inner perimeter and the outer perimeter, and wherein a density of radial ribs in a first region is greater than a density of radial ribs in a second region.

9. The barrier system of claim 7, wherein the first projection includes an end and a shaft that extends between the retainer body and the end, wherein the end is wider than at least a portion of the shaft.

10. The barrier system of claim 7, wherein the first projection is configured to move between adjacent slots of the plurality of slots in a ratcheting manner.

11. The barrier system of claim 7, wherein the retainer further includes a second projection extending from the body in an opposite direction from the first projection, and wherein the second projection includes an opening.

12. The barrier system of claim 7, wherein the body is configured to move about the channel between a first position where walls of the channel are at least partially in contact and a second position where the walls are spaced apart, and wherein the retainer is configured to secure the body in the first position.

13. The barrier system of claim 7, wherein:
the body further includes a second groove extending at least partially between the outer perimeter and the inner perimeter, the second groove includes a second plurality of slots, wherein each second slot oriented along a circumferential direction of the body;
the channel is disposed between the first groove and the second groove;
a second projection that extends from the retainer body; and
the second projection is configured to be selectively received within one slot of the second plurality of slots.

14. The barrier system of claim 13, wherein the retainer is configured to couple to the body where the retainer body is substantially perpendicular to an axis along a length of the channel.

15. A barrier for use in an electrical system, the barrier comprising:
a body formed from a plurality of spaced apart first ribs;
an aperture formed at a geometric center of the body;
a channel extending from the aperture to an outer perimeter of the body;
a first groove disposed on a first side of the channel and extending at least partially between the aperture and the outer perimeter, the first groove including a first plurality of elongated slots arranged in a circumferential direction of the body; and
a second groove disposed on a second side of the channel and extending at least partially between the aperture and the outer perimeter, the second groove including a second plurality of elongated slots arranged in the circumferential direction of the body.

16. The barrier of claim 15, wherein a support section is disposed proximate to the first groove and includes an opening configured to receive a tool for connecting the body to a support, the support section includes a plurality of spaced apart second ribs, wherein the second ribs are oriented in a denser pattern than the first ribs.

17. The barrier of claim 15, wherein a first axis is a diameter of the body and extends along the channel, and wherein the body is symmetric about the first axis.

18. The barrier of claim 15, wherein the body includes a first inner wall and a second inner wall that together at least partially form a boundary of the channel, wherein the body is movable between a first position wherein the first inner wall and the second inner wall are spaced apart by a first distance and a second position where the first inner wall and the second inner wall are spaced apart by a second distance greater than the first distance.

19. The barrier of claim 18, wherein the body further includes a compressive region spaced apart from the channel, wherein the compressive region is configured to flex as the body moves between the first position and the second position.

20. The barrier of claim 15, wherein each slot of the first plurality of elongated slots is offset from adjacent slots of the first plurality of slots in the circumferential direction.

21.-26. (canceled)
